(19) United States
(12) Patent Application Publication
(10) Pub. No.: US 2025/0082103 A1
(43) Pub. Date: Mar. 13, 2025

(54) Suction Cups Equipped Travel Pillow

(71) Applicants: Joseph Coplen, Washington, OK (US); Marid Coplen, Washington, OK (US)

(72) Inventors: Joseph Coplen, Washington, OK (US); Marid Coplen, Washington, OK (US)

(21) Appl. No.: 18/505,177

(22) Filed: Nov. 9, 2023

Related U.S. Application Data
(60) Provisional application No. 63/582,332, filed on Sep. 13, 2023.

(51) Int. Cl. A47C 16/00; F16B 47/00

(52) U.S. Cl. CPC A47C 16/00; F16B 47/00; A47G 2009/1018

(57) ABSTRACT

A travel-enhancing pillow device designed to be used in a vehicle for leaning against a window or interior surface of the vehicle. The pillow includes a pillow cover and a memory foam or cushion member secured inside the pillow cover. The memory foam is accessible through an open side surface by detaching a flap member. The pillow device includes suction cups for attaching the pillow to a window or interior surface of the vehicle by creating a vacuum between the suction cups and the vehicle surface. The suction cups can be detached to enable users to use the pillow device as a conventional pillow. The memory foam can be removed to wash the pillow cover. The pillow offers a safe and secure means to lean against a surface in a vehicle to relax and sleep.

### CROSS-REFERENCE TO RELATED APPLICATION

The present application claims priority to, and the benefit of, U.S. Provisional Application No. 63/582,332, which was filed on Sep. 13, 2023, and is incorporated herein by reference in its entirety.

### FIELD OF THE INVENTION

The present invention generally relates to the field of pillows. More specifically, the present invention relates to a novel travel pillow that enables passengers to travel more comfortably on planes, trains, buses, cars, and more. The pillow includes a pillow cover and a memory foam member. The pillow includes suction cups that enable the pillow to suction itself to the wall or window of a vehicle and to enable a passenger to lean against the pillow. The suction cups can be removed from the rear side so that the pillow can be traditionally used behind the head. Accordingly, the present disclosure makes specific reference thereto. Nonetheless, it is to be appreciated that aspects of the present invention are also equally applicable to other like applications, devices, and methods of manufacture.

### BACKGROUND

By way of background, people often travel long distances for work, visiting friends and family, and for other different purposes. Long-distance travel by vehicles such as by car, train, or plane, often involves extended periods of sitting in a confined space. Due to a lack of bodily movement, passengers may want to relax or sleep during these journeys to make the time pass more comfortably. Many individuals also readily fall asleep during commuting. Commonly, when people attempt to rest in a sitting position in a vehicle, people often lean to one side such as a side surface of the vehicle with their neck against the backrest or window. However, over time, this can lead to discomfort and pain in the neck and shoulders.

Trying to keep the head upright while sleeping in a vehicle can be challenging and uncomfortable for individuals. Passengers who cannot find a comfortable sleeping position may become irritated and restless during long trips, leading to a less enjoyable travel experience. Existing solutions such as neck rest pillows are used by people and are designed to provide support for the neck. However, such devices are generally worn around the neck by an individual, which can be bulky and may not be effective in leaning against a window or side surface. Without a stable and cushioned support, leaning a head against a hard surface, like a window or the side of the vehicle, can potentially lead to injury, especially when there is movement or turbulence during the journey. People desire an improved and compact pillow that can overcome problems faced by individuals in comfortably leaning against a vehicle's interior.

Therefore, there exists a long-felt need in the art for an improved and compact pillow designed to be used to lean up against a vehicle's interior in a car, truck, SUV, van, plane, train, or other travel vehicles. Additionally, there is a long-felt need in the art for a travel sleeping accessory device that enables passengers to lean against the vehicle's interior or window. Moreover, there is a long-felt need in the art for a compact memory foam pillow that can be securely attached to the interior surface of a vehicle or can be used as a conventional pillow. Further, there is a long-felt need in the art for a compact pillow device that alleviates discomfort, and neck or shoulder pain, and eliminates injuries while leaning against an interior of a vehicle to sleep or relax. Furthermore, there is a long-felt need in the art for a small travel pillow that enhances the comfort and relaxation of travelers during their journeys in vehicles. Finally, there is a long-felt need in the art for a travel pillow device that functions as a practical and comfortable alternative to large and bulky conventional devices such as neck pillows to provide support for leaning against the vehicle interior or window.

The subject matter disclosed and claimed herein, in one embodiment thereof, comprises a pillow device for use in a vehicle for a passenger to lean against the vehicle's interior surface or window. The compact pillow device features a pillow cover and a memory foam insert member. The pillow cover includes a plurality of exterior surfaces including a front surface, a rear surface, a pair of side surfaces, a top surface, and a bottom surface, wherein the exterior surfaces form a cavity therebetween for securing the memory foam therein. The rear surface has at least one suction cup (i.e., a pair of suction cups) attached thereto, wherein the suction cup(s) are attached to the interior surface of a vehicle by creating a partial vacuum between the suction cups and the interior surface when the pillow is pushed against the wall. A user leans on the front surface to lean against the interior surface of the vehicle to sleep and relax. The suction cups can be removed from the rear side so that the pillow can be traditionally used behind the head.

In this manner, the pillow device of the present invention accomplishes all of the foregoing objectives and provides users with a small memory foam pillow designed to be used in a car, truck, SUV, van, plane, train, or other travel vehicle. A passenger can attach the pillow against a surface using a suction cup(s) and lean against the pillow to lean up against the window or surface of the vehicle to maintain comfort and nap or just relax. The suction cups can be removed enabling the use of the pillow device as a conventional pillow. The pillow replaces bulky neck rests and provides a safe place to lean against during travel.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a compact pillow device for use in a vehicle to lean against the vehicle interior or window. The compact pillow device comprising a pillow cover and a memory foam. The pillow cover includes a plurality of exterior surfaces including a front surface, a rear surface, a pair of side surfaces, a top surface, and a bottom surface, wherein the exterior surfaces form a cavity therebetween for securing the memory foam therein, wherein the rear surface has at least one suction cup, for example a pair of suction cups, attached thereto, wherein the suction cups are attached to the interior surface of a vehicle by creating a partial vacuum between the suction cups and the interior surface. A user leans on the front surface to lean against the interior surface of the vehicle to sleep and relax.

In a further embodiment, a traveling-enhancing pillow device is disclosed. The pillow device includes a pillow cover configured to enclose a memory foam therein. The pillow cover includes a plurality of exterior surfaces including a front surface, a rear surface, a pair of side surfaces, a top surface, and a bottom surface, wherein the exterior surfaces form a cavity therebetween for securing the memory foam therein. One side surface includes a flap member with a hook and loop fastener for accessing the cavity to insert and remove the memory foam. The rear surface of the pillow cover includes one or more suction cups, the suction cups are detachably attached to the rear surface, and the pillow device is attached to an interior surface of a vehicle by pressing the suction cups to create a vacuum between the suction cups and the interior surface of the vehicle. A user leans against the attached pillow device to lean against the interior surface without sliding or slipping. The pillow device is generally in the range of 4.0″ to 12.0″ (L)×3.0″ to 9.0″ (W)×1.0″ to 4.0″ (H).

In yet another embodiment, a method of attaching a memory foam pillow to a window or interior surface of a vehicle for a user to lean against the pillow is described. The method includes the steps of providing the memory foam pillow, the pillow includes a pillow cover and a memory foam enclosed by the pillow cover. In one exemplary embodiment, the pillow includes a pair of suction cups on one of the surfaces of the pillow cover, placing the suction cups on the interior surface or window of the vehicle, pressing the pillow against the interior surface/window of the vehicle, creating a vacuum between the suction cups and the interior surface, and leaning against the pillow to relax and sleep.

In yet another embodiment, the suction cups are detachable from the pillow enabling a user to use the pillow as a conventional backrest during sitting or as a pillow device for sleeping in a supine or prone position.

Numerous benefits and advantages of this invention will become apparent to those skilled in the art to which it pertains upon reading and understanding of the following detailed specifications.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of the compact travel pillow of the present invention in accordance with the disclosed structure;

FIG. 2 illustrates a rear perspective view of the compact travel pillow of FIG. 1 in accordance with the disclosed structure;

FIG. 3 illustrates a perspective view showing the memory foam being inserted into the pillow cover to form the compact travel pillow of the present invention in accordance with the disclosed structure;

FIG. 4 illustrates a partial side perspective view showing the traveling comfort pillow device of the present invention attached to an interior of a vehicle in accordance with the disclosed structure;

FIG. 5 illustrates a perspective view of a user leaning against the traveling comfort pillow device adhered to a vehicle window in accordance with the disclosed architecture; and

FIG. 6 illustrates a perspective view of another user using the traveling comfort pillow device of the present invention on an airplane in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved and compact pillow designed to be used to lean up against a vehicle's interior in a car, truck, SUV, van, plane, train, or other travel vehicles. Additionally, there is a long-felt need in the art for a travel sleeping accessory device that enables passengers to lean against the vehicle's interior or window. Moreover, there is a long-felt need in the art for a compact memory foam pillow that can be securely attached to the interior surface of a vehicle or can be used as a conventional pillow. Further, there is a long-felt need in the art for a compact pillow device that alleviates discomfort, and neck or shoulder pain and eliminates injuries while leaning against an interior of a vehicle for sleep or relaxation. Furthermore, there is a long-felt need in the art for a small travel pillow that enhances the comfort and relaxation of travelers during their journeys in vehicles. Finally, there is a long-felt need in the art for a travel pillow device that functions as a practical and comfortable alternative to large and bulky conventional devices such as neck pillows to provide support for leaning against the vehicle interior or window.

The present invention, in one exemplary embodiment, is a method of attaching a memory foam pillow to a window or interior surface of a vehicle for a user to lean against the pillow. The method includes the steps of providing the memory foam pillow, the pillow includes a pillow cover and a memory foam enclosed by the pillow cover. The pillow includes at least one suction cup, i.e., a pair of suction cups, on one of the surfaces of the pillow cover, placing the suction cups on the interior surface or window, pressing the pillow against the interior surface/window, creating a vacuum between the suction cups and the interior surface, and leaning against the pillow to relax and sleep.

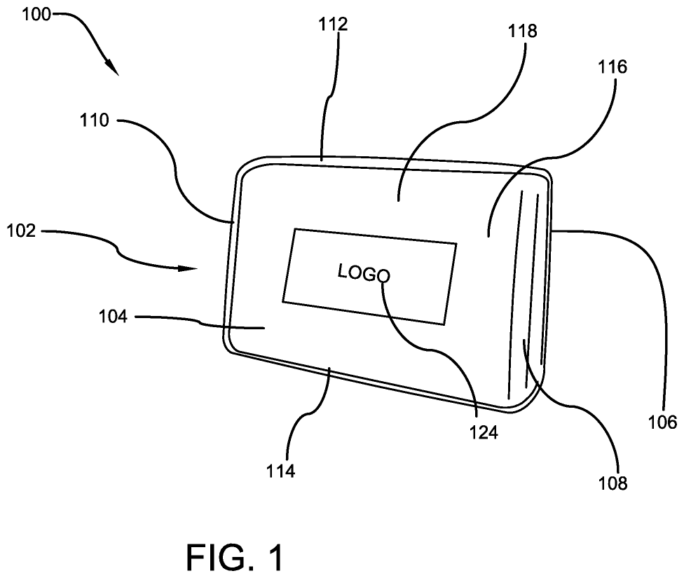

Referring initially to the drawings, FIG. 1 illustrates a front perspective view of one potential embodiment of the compact travel pillow of the present invention in accordance with the disclosed structure. The travel pillow 100 of the present invention is designed to be used in a car, truck, SUV, van, plane, train, or other travel vehicle to enable a passenger to lean up against the vehicle interior or window, against the pillow, to maintain comfort. More specifically, the travel pillow 100 includes a non-slippery pillow cover 102 comprising a front surface 104, a rear surface 106, a closed side surface 108, an open side surface 110, a top surface 112, and a bottom surface 114. The exterior surfaces form a cavity 116 therebetween for holding a cuboidal memory foam 118.

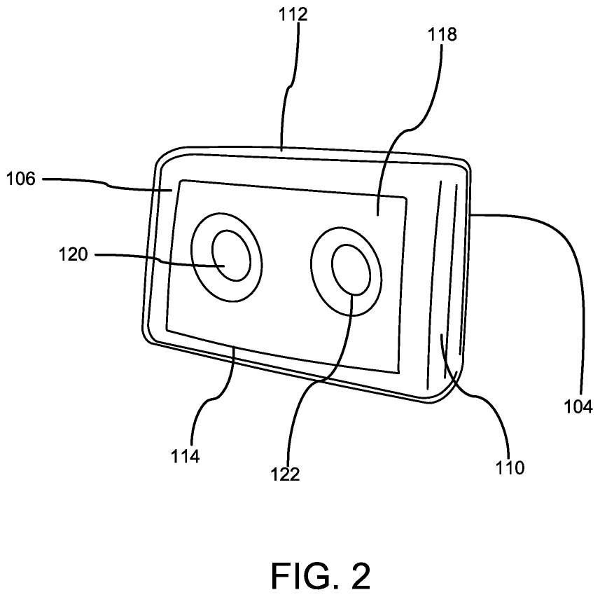

Referring to FIGS. 1 and 2, the rear surface 106 of the pillow cover 102 includes a pair of suction cups 120, 122 for enabling the pillow 100 (pillow cover 102 with accommodated memory foam 118) to suction and attach onto a surface such as a window or any interior surface of a vehicle. The suction cups 120, 122 are positioned preferably equidistant from the side surfaces 108, 110. The suction cups 120, 122 are preferably circular in shape, however, any other geometrical shape such as square, circle, or any other shape can be used in the present invention. In use, the pillow 100 is positioned on any surface with the rear surface 106 facing the surface on which the pillow 100 is to be attached and is pushed to enable the suction cups 120, 122 to suction to the surface, thereby eliminating any slipping or sliding of the pillow 100 during use. A user can lean against the front surface 104 to relax and sleep without any neck and shoulder pain. The front surface 104 can include any logo or indicia 124 for branding or marketing purposes.

The travel memory foam pillow 100 comes in various sizes such as in the range of 4.0″ to 12.0″ (L)×3.0″ to 9.0″ (W)×1.0″ to 4.0″ (H). The dimensions of the memory foam 118 are such that it can be easily stored inside the pillow cover 102. The pillow cover 102 and the memory foam 118 can comprise washable materials selected from a group consisting of cotton, a flannel, a silk, a polyester material, and more.

The primary use of the travel accessory device 100 is to lean against a surface during travel in a vehicle but can also be used as a conventional vehicle by detaching the suction cups 120, 122. The pillow 100 is lightweight and certain weights of specific materials can be used for making the pillow 100. The travel pillow device 100 can vary from about 100 grams to about 500 grams depending on the size, design, and manufacturing specifications.

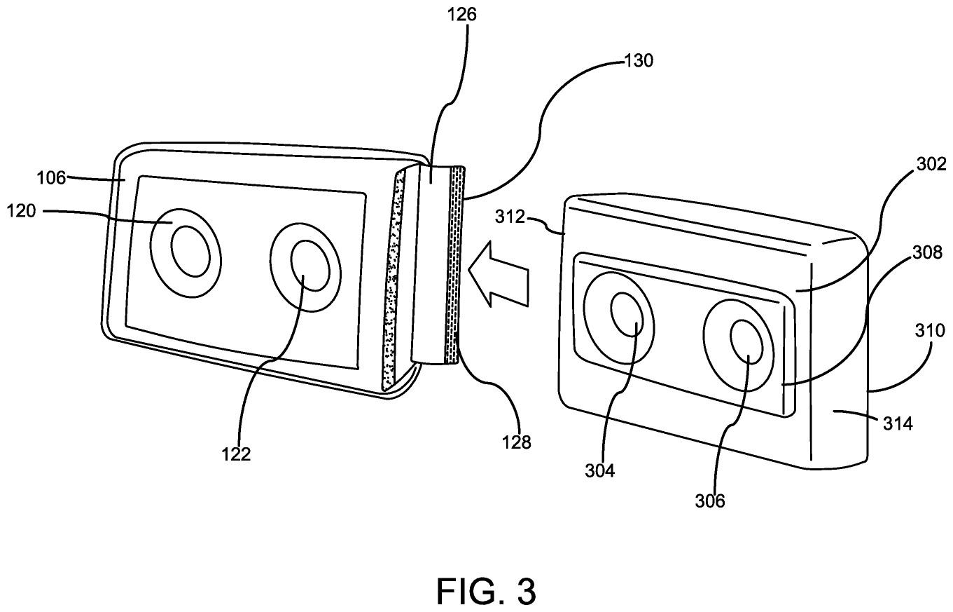

FIG. 3 illustrates a perspective view showing the memory foam 118 being inserted into the pillow cover 102 to form the compact travel pillow 100 of the present invention in accordance with the disclosed structure. The memory foam 118 is removably inserted into the cavity 116 enabling a user to wash the pillow cover 102. The open side surface 110 of the pillow 100 has a flap member 126. The flap member 126 is sewn along the front surface 104 and has a hook and loop fastener 128 disposed along the longitudinal edge 130 thereof. The hook and loop fastener 128 can releasably fasten to the rear surface 106 for selectively closing the open side surface 110. In use, the memory foam 118 with the rear surface 302 thereof facing towards the rear surface 106 is inserted into the cavity 116 of the pillow cover 102 and then, the flap member 126 is fastened to close the open side surface 110.

The rear surface 302 of the memory foam 118 also has a pair of suction cups 304, 306 which are aligned with the suction cups 120, 122 of the pillow cover 102. The suction cups 304, 306 are attached to a detachable adhesive member 308 which can be removed for using the memory foam 118 as a conventional memory foam pillow. It will be apparent to a person skilled in the art that the suction cups 120, 122 can selectively be detached from the rear surface 106 thereof for using the travel pillow 100 as a conventional pillow for a backrest.

The memory foam 118 may include any cushioning material for maintaining the shape of the pillow. The cushioning material also does not enable the memory foam 118 to lose its shape after repeated use. The cushioning material can vary and may include bonded or non-bonded batting, memory foam rubber, or any other type of pliable material.

When the memory foam member 118 is secured inside the pillow cover 102, the rear surface 302 adheres to the rear surface 106 of the pillow cover 102, the front surface 310 adheres to the front surface 104, the side surfaces 312, 314 adhere to the surfaces 108, 110, respectively.

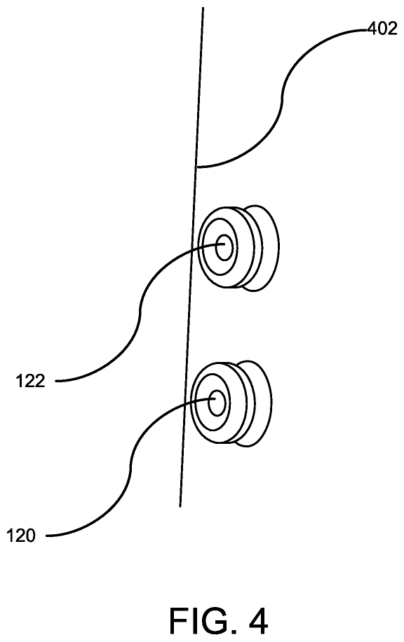

FIG. 4 illustrates a side perspective view showing the traveling comfort pillow device of the present invention attached to the interior of a vehicle in accordance with the disclosed structure. The suction cups 120, 122 of the pillow cover 102 are attached to the interior surface 402 of a vehicle without sliding or any movement even in a running vehicle. The suction cups 120, 122 are preferably concave, flexible, and made of rubber or silicon. In use, when the pillow device 100 is pressed against the surface 402, the suction cups 120, 122 are pressed against the surface 402 and create a seal. The air inside the suction cups 120, 122 is eliminated to create a partial vacuum within the cups 120, 122 causing the cups 120, 122 to adhere to the surface 402.

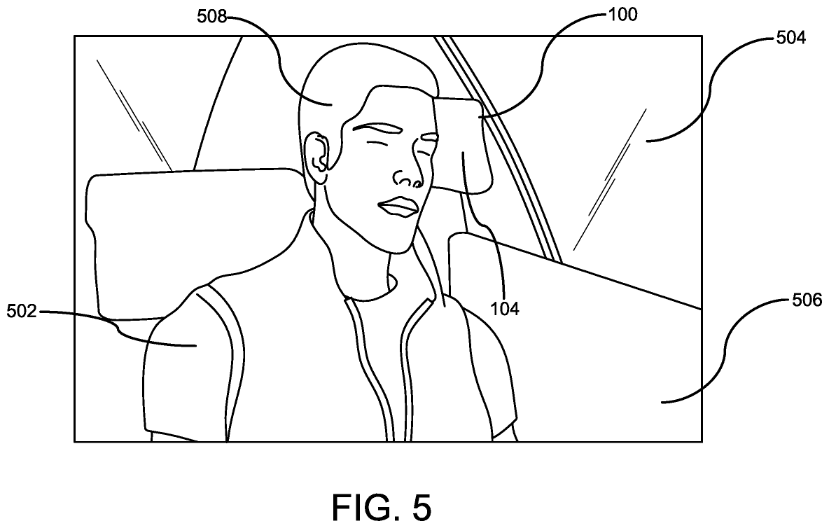

FIG. 5 illustrates a perspective view of a user leaning against the traveling comfort pillow device adhered to a vehicle window in accordance with the disclosed architecture. In the present embodiment, the user 502 attaches the travel pillow device 100 to the window 504 of a vehicle 506 and rests the head 508 easily. The pillow device 100 not only eliminates resting of the head on the hard window but also provides a non-slippery front surface 104, thereby preventing injury and providing relaxation.

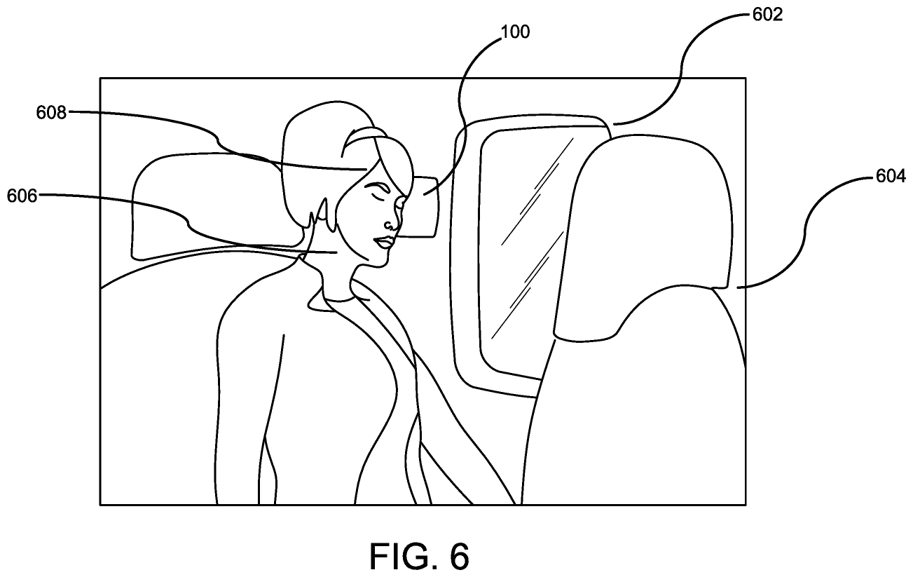

FIG. 6 illustrates a perspective view of another user using the traveling comfort pillow device of the present invention on an airplane in accordance with the disclosed structure. In the present embodiment, the pillow device 100 is placed on an interior surface 602 of an airplane 604 enabling the user 606 to lean the head 608 against the surface 602 using the pillow device 100.

In one embodiment of the present invention, the memory foam includes a vibration module (not shown) that can start vibrating when a user leans against the pillow device 100, thereby providing the user a massage. The vibration module can also be selectively activated using a push button (not shown) disposed on the pillow cover.

The suction cup attached traveling pillow device 100 of the present invention can be made in any geometric shape and any size. Further, the pillow device 100 is compact and easy to store. The pillow device 100 is susceptible to a low cost of manufacture with regard to both materials and labor which accordingly is then amenable to low prices of sale to the consuming public, thereby making such pillow economically available to the buying public. The pillow device 100 can also be provided by transport services such as airlines as a travel accessory to passengers.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “travel pillow device”, “pillow device”, “traveling comfort pillow device”, “compact travel pillow”, and “suction cup attached traveling pillow device” are interchangeable and refer to the suction cup attached traveling pillow device 100 of the present invention.

Notwithstanding the foregoing, the suction cup attached traveling pillow device 100 of the present invention can be of any suitable size and configuration as is known in the art without affecting the overall concept of the invention, provided that it accomplishes the above-stated objectives. One of ordinary skill in the art will appreciate that the suction cup attached traveling pillow device 100 as shown in the FIGS. 1-6 is for illustrative purposes only, and that many other sizes and shapes of the suction cup attached traveling pillow device 100 are well within the scope of the present disclosure. Although the dimensions of the suction cup attached traveling pillow device 100 are important design parameters for user convenience, the suction cup attached traveling pillow device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A travel pillow for use with an interior of a vehicle, the travel pillow comprising:
a pillow cover including a front surface, a rear surface, a closed side surface, a selectively openable side surface, a top surface, and a bottom surface;
wherein said pillow cover forming a cavity therein for holding a removable memory foam;
wherein said selectively openable side surface having a hook and loop fastener;
wherein said rear surface having a least one suction cup for attaching said travel pillow to an interior surface of the vehicle; and
further wherein said front surface facing a user for the user to lean against.

2. The travel pillow of claim 1, wherein said rear surface having a pair of suction cups.

3. The travel pillow of claim 2, wherein said pillow cover is washable.

4. The travel pillow of claim 3, wherein said pair of suction cups equidistant from a respective said closed side surface and said selectively openable side surface.

5. The travel pillow of claim 4, wherein said travel pillow having a length from 4.0″ to 12.0″, a width from 3.0″ to 9.0″, and a height from 1.0″ to 4.0″.

6. The travel pillow of claim 5, wherein said pillow cover having a material selected from the group consisting of a cotton, a flannel, a silk, and a polyester.

7. The travel pillow of claim 6, wherein said memory foam is cuboidal.

8. The travel pillow of claim 7, wherein said pair of suction cups are selectively removable.

9. A travel pillow for use with an interior of a vehicle, the travel pillow comprising:
a pillow cover including a front surface, a rear surface, a closed side surface, a selectively openable side surface, a top surface, and a bottom surface;
wherein said pillow cover forming a cavity therein for holding a removable memory foam;
wherein said selectively openable side surface having a hook and loop fastener;
wherein said rear surface having a pair of suction cups for attaching said travel pillow to an interior surface of the vehicle;
wherein said front surface facing a user for the user to lean against; and
further wherein said pair of suction cups are selectively removable.

10. The travel pillow of claim 9, wherein said pillow cover is washable.

11. The travel pillow of claim 10, wherein said pair of suction cups equidistant from a respective said closed side surface and said selectively openable side surface.

12. The travel pillow of claim 11, wherein said travel pillow having a length from 4.0″ to 12.0″, a width from 3.0″ to 9.0″, and a height from 1.0″ to 4.0″.

13. The travel pillow of claim 12, wherein said pillow cover having a material selected from the group consisting of a cotton, a flannel, a silk, and a polyester.

14. A travel pillow for use with an interior of a vehicle, the travel pillow comprising:
a pillow cover including a front surface, a rear surface, a closed side surface, a selectively openable side surface, a top surface, and a bottom surface;
wherein said pillow cover forming a cavity therein for holding a removable memory foam;
wherein said selectively openable side surface having a hook and loop fastener;
wherein said rear surface having a pair of suction cups for attaching said travel pillow to an interior surface of the vehicle;
wherein said front surface facing a user for the user to lean against;
wherein said pair of suction cups of said cover are selectively removable; and
further wherein said removable memory foam having a pair of suction cups aligned with said pair of suction cups of said pillow cover.

15. The travel pillow of claim 14, wherein said pillow cover is washable.

16. The travel pillow of claim 15, wherein said pair of suction cups of said cover equidistant from a respective said closed side surface and said selectively openable side surface.

17. The travel pillow of claim 16, wherein said travel pillow having a length from 4.0″ to 12.0″, a width from 3.0″ to 9.0″, and a height from 1.0″ to 4.0″.

18. The travel pillow of claim 17, wherein said pillow cover having a material selected from the group consisting of a cotton, a flannel, a silk, and a polyester.

19. The travel pillow of claim 18, wherein said travel pillow having a weight from 100 grams to 500 grams.

20. The travel pillow of claim 19, wherein said removable memory foam having a material selected from the group consisting of a batting and a memory foam rubber.
